(19) United States
(12) Patent Application Publication
(10) Pub. No.: US 2017/0161718 A1
(43) Pub. Date: Jun. 8, 2017

(54) METHOD, SERVER AND TERMINAL FOR GENERATING QUICK RESPONSE CODE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Youxing ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/238,853

(22) Filed: Aug. 17, 2016

Related U.S. Application Data
(63) Continuation of application No. PCT/CN2016/089511, filed on Jul. 10, 2016.

(30) Foreign Application Priority Data
Dec. 4, 2015 (CN) 2015108858369

(51) Int. Cl. G06Q 20/32; G06K 7/10; G06K 7/14; G06Q 30/06

(52) U.S. Cl. CPC G06Q 20/3276; G06Q 30/0633; G06K 7/1095; G06K 7/1417

(57) ABSTRACT

Embodiments of the present disclosure provide a method, a server and a terminal for generating a quick response code, an information processing method and device, and an information system. The method for generating a quick response code includes: receiving a quick response code request of a user; obtaining first general information in the quick response code request, to generate first order information; and generating a quick response code according to the first order information. By means of the method for generating a quick response code, the information processing method and device, and the information system provided in the embodiments of the present disclosure, it is implemented that a quick response code identifiable to more payment tools is provided, so that a user does not need to determine which payment tool to be used to perform code scanning, thereby making a payment process more convenient and faster. Meanwhile, costs in aspects of user guidance and business operation are reduced.

### CROSS-REFERENCE TO RELATED APPLICATIONS

The present disclosure is a continuation of International Application No. PCT/CN2016/089511, with an international filing date of Jul. 10, 2016, which is based upon and claims priority to Chinese Patent Application No. 201510885836.9, filed on Dec. 4, 2015, the entire contents of all of which are incorporated herein by reference.

### TECHNICAL FIELD

This application relates to information processing technologies, and particularly to a method, a server and a terminal for generating a quick response code.

### BACKGROUND

With the development of terminal technologies, people's consumption patterns keep changing, and offline consumption has gradually developed to online consumption, and people increasingly tend to make payment by terminal devices during shopping. Taking a quick response code payment as an example, in actual application scenarios, the most common code scanning payment applications are, for example, WeChat, and Alipay, etc. At present, quick response codes used for direct payment between various code scanning payment applications cannot be used generally, which therefore causes many inconveniences.

For example, if a user fails to notice that a quick response code is generated by WeChat payment, and scanning code with Alipay payment instead will not succeed in payment. Therefore, the foregoing electronic transaction manners have at least the following problems: in one aspect, a user needs to correspondingly adjust or switch a code scanning application according to an actual case; and in another aspect, a merchant needs to consider how to guide a user to use a payment platform corresponding to a quick response code to scan code, and further needs to consider the presentation and design work for multiple quick response codes on a product, so that operation costs are increased.

### SUMMARY

An objective of embodiments of the present disclosure is to provide a method for generating a quick response code, an information processing method a server, and a terminal, so as to provide a quick response code identifiable for more payment tools, thereby improving payment experience of a user.

According to an aspect of an embodiment of the present disclosure, a method for generating a quick response code at a server is provided, including: receiving a quick response code request of a user; obtaining first general information in the quick response code request to generate first order information; and generating a quick response code according to the first order information.

According to another aspect of an embodiment of the present disclosure, an information processing method at a terminal is provided, including: scanning a quick response code to obtain first general information; identifying payment information of a code scanning application; and sending second order information to a server device according to the first general information and the payment information.

According to an embodiment of the present disclosure, a server is provided, including: at least one processor; and a memory communicably connected with the at least one processor for storing instructions executable by the at least one processor, wherein execution of the instructions by the at least one processor causes the at least one processor to perform an above disclosed method at the server side.

According to an embodiment of the present disclosure, a terminal is provided, including: at least one processor; and a memory communicably connected with the at least one processor for storing instructions executable by the at least one processor, wherein execution of the instructions by the at least one processor causes the at least one processor to perform an above disclosed method at the terminal side.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart showing a method for generating a quick response code according to Embodiment 1 of the present disclosure;

FIG. 2 is a flow chart showing an information processing method according to Embodiment 2 of the present disclosure;

FIG. 3 is a logic block diagram showing a server device according to Embodiment 3 of the present disclosure;

FIG. 4 is a logic block diagram showing a terminal device according to Embodiment 4 of the present disclosure;

FIG. 5 illustrates a block diagram of a server according to an embodiment of the present disclosure; and,

FIG. 6 illustrates a block diagram of a terminal according to an embodiment of the present disclosure.

### DETAILED DESCRIPTION

A basic concept of the embodiments of the present disclosure is to provide a technical solution in which processing is performed based on first general information in a quick response code request initiated by a user, so as to obtain a universal quick response code. It can be seen that during generating a quick response code, only general information such as commodity information, price information and the like is considered. Therefore, in an aspect, a quick response code provided for a user may be recognized by more payment tools, so that the user does not need to determine which payment tool to be used to perform code scanning, thereby making a payment process more convenient and faster, and improving payment experience of a user. In another aspect, a merchant does not need to consider how to guide a user to use a payment tool corresponding to a quick response code to perform code scanning, thereby greatly reducing the costs in aspects of user guidance and business operation.

A method for generating a quick response code, an information processing method and device, and an information system in exemplary embodiments of the present disclosure are described below in detail with reference to the accompanying drawings.

### Embodiment 1

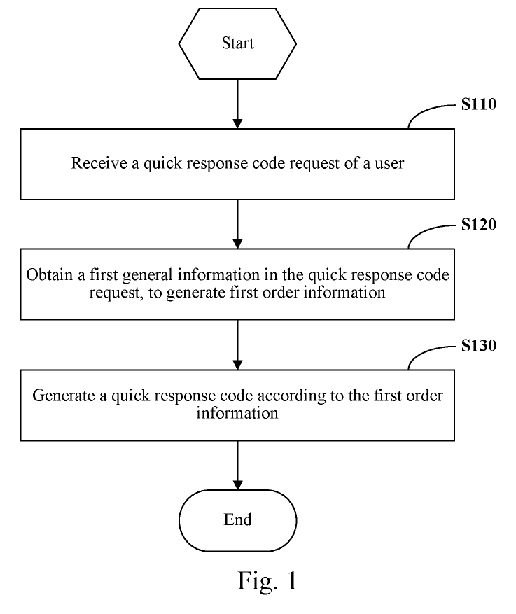

FIG. 1 is a flow chart of a method for generating a quick response code according to Embodiment 1 of the present disclosure. For example, the method may be executed on a server. The server may be a server device of a merchant, for example, Taobao Mall, and Jingdong Mall, etc.

Referring to FIG. 1,in step S110, a quick response code request of a user is received.

In an actual application, after a user logs in to a shopping APP or an H5 page provided by a merchant on a terminal device (for example, a computer, and a mobile phone, etc.) and chooses a commodity, the user may click a code scanning payment button provided on a purchase interface, and therefore a server may receive a quick response code request of the user.

In step S120, a first general information in the quick response code request is obtained, to generate first order information.

It should be noted that the first general information may include commodity information and/or price information. For example, the user chooses a LeTV mobile phone “LE is”, and the current price information is 1099 Yuan.

In step S130, a quick response code is generated according to the first order information.

Specifically, an existing technology of generating a quick response code may be used, and text information and value information represented by the commodity information and/or price information are recorded via a generated graph.

To enable a user to scan a quick response code provided by a server to enter a payment page, further, the method also includes that the quick response code is displayed by a proxy page. After generating the quick response code, the server may automatically jump to the proxy page that displays the quick response code.

The method for generating a quick response code in this embodiment, generates first order information by retrieving first universal information in a received quick response code request and further generates a quick response code according to the first order information. Compared with prior art, in this embodiment, a quick response code eventually provided for a user is a general quick response code and does not include payment information, which thereby achieves to provide a quick response code recognizable for more payment tools, so that a user does not need to determine which payment tool to be used to perform code scanning, thereby making a payment process more convenient and faster.

In addition, from the perspective of a merchant, there is no need to consider how to guide a user to use a payment tool corresponding to a quick response code to perform code scanning, thereby greatly reducing the costs in aspects of user guidance and business operation.

### Embodiment 2

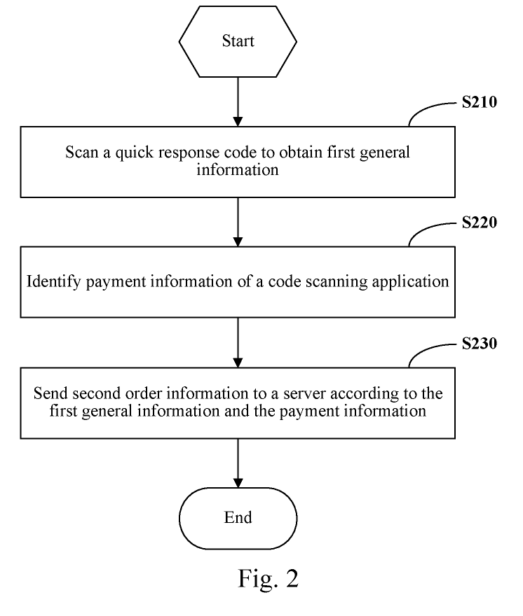

FIG. 2 is a flow chart of an information processing method according to Embodiment 2 of the present disclosure. For example, the method may be executed on a terminal.

Referring to FIG. 2, in step S210, a quick response code is scanned to obtain first general information.

Herein, the first general information may include commodity information and/or price information. Specifically, because a quick response code provided by a server for a terminal device records the first universal information, after scanning code, the terminal device may obtain the commodity information and/or the price information.

In step S220, payment information of a code scanning application is identified.

Specifically, which payment tool used by a user to perform a code scanning operation may be identified, so as to determine a code scanning environment of the user, and the barcode scanning environment of the user represents a payment manner used by the user.

In step S230, second order information is sent to a server device according to the first general information and the payment information.

In the foregoing embodiment, first order information generated by the first general information is not the same as an order in prior art, and does not include the payment information and therefore may be understood as a temporary order. Herein, the payment information is obtained by step S220, that is, at this time, order information is completed. The second order information herein may be understood as complete order information, and the complete order information is sent to a server, so that the server initiates an order request to a third-party payment platform server.

Further, the method also includes jumping to a payment page in response to the second order information. In a specific implementation, the terminal device responds to order information and invokes a third-party payment platform interface (for example, a WeChat payment interface, etc.), so as to facilitate a subsequent payment operation by a user.

The information processing method in this embodiment, according to first general information obtained through code scanning and identified payment information, sends second order information to a server, so that an ordering operation and a payment operation can be completed without determining which payment tool to be used, thereby improving payment experience of a user.

### Embodiment 3

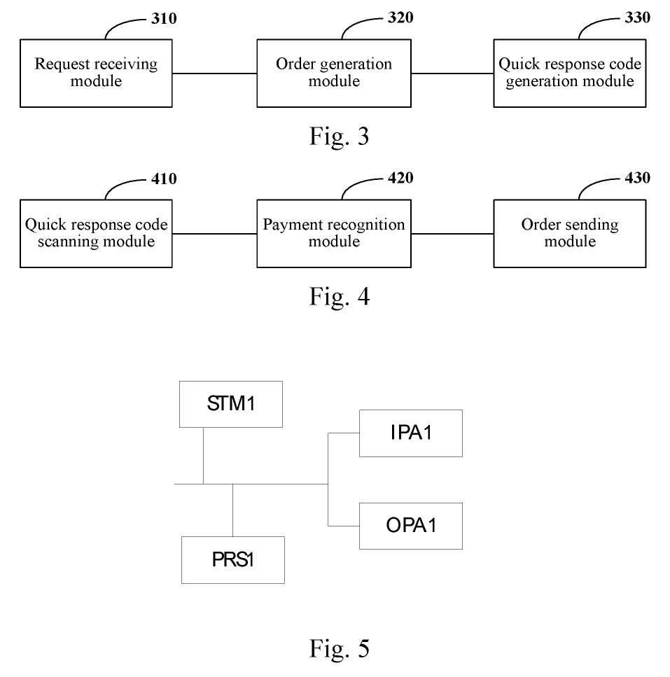

FIG. 3 is a logic block diagram of a server device according to Embodiment 3 of the present disclosure. The server device may be configured to execute the method steps in the embodiment shown in FIG. 1.

Referring to FIG. 3, the server device includes a request receiving module 310, an order generation module 320, and a quick response code generation module 330. The request receiving module 310, the order generation module 320, and the quick response code generation module 330 are sequentially connected.

The request receiving module 310 receives a quick response code request of a user.

The order generation module 320 obtains a first general information in the quick response code request, to generate first order information.

The first general information herein may include commodity information and/or price information.

The quick response code generation module 330 generates a quick response code according to the first order information.

Further, the server device may also include a quick response code presentation module (not shown) that displays the quick response code by a proxy page.

Correspondingly, the server device may further include:

a page jump module (not shown) that automatically jumps to the proxy page that presents the quick response code after the quick response code is generated.

The server device in this embodiment generates first order information by obtaining a first general information in a received quick response code request, and further generates a quick response code according to the first order information. Compared with the prior art, in this embodiment, a quick response code eventually provided for a user is a universal quick response code and does not include payment information, which thereby achieves to provide a quick response code recognizable for more payment tools, so that a user does not need to determine which payment tool to be used to perform code scanning, thereby making a payment process more convenient and faster. Meanwhile, costs in aspects of user guidance and business operation are reduced.

### Embodiment 4

FIG. 4 is a logic block diagram of a terminal device according to Embodiment 4 of the present disclosure. The terminal device may be configured to execute the method steps in the embodiment shown in FIG. 2.

Referring to FIG. 4, the terminal device includes a quick response code scanning module 410, a payment recognition module 420, and an order sending module 430. The quick response code scanning module 410, the payment recognition module 420, and the order sending module 430 are sequentially connected.

The quick response code scanning module 410 scans a quick response code to obtain first general information.

The payment manner recognition module 420 identifies payment information of a code scanning application.

The order sending module 430 sends second order information to a server device according to the first universal information and the payment information.

As an optional implementation of this embodiment, the terminal device may further include a payment page jump module (not shown) that jumps to a payment page in response to the second order information.

The terminal device in this embodiment, according to first general information obtained through code scanning and identified payment information, sends second order information to a server device, so that an ordering operation and a payment operation can be completed without determining which payment tool to be used, thereby improving payment experience of a user.

### Embodiment 5

An information system includes the server device in the foregoing Embodiment 3 and the terminal device in the foregoing Embodiment 4. After the server device interacts with the terminal device, the terminal device sends second order information to the server device. Compared with prior art, the information system in this embodiment has the following technical effects:
in an aspect, a user is provided with a quick response code recognizable for more payment tools, so that the user does not need to determine which payment tool to be used to perform code scanning, thereby making a payment process more convenient and faster, and greatly improving payment experience of a user; and
in another aspect, a merchant does not need to consider how to guide a user to use a payment tool corresponding to a quick response code to perform code scanning, thereby lowering costs in aspects of user guidance and business operation.

According to an embodiment of the present disclosure, there is provided with a non-transitory computer-readable storage medium storing executable instructions that, when executed by an electronic apparatus, cause the electronic apparatus to perform any one of above disclosed methods at the server side.

According to an embodiment of the present disclosure, there is provided with a non-transitory computer-readable storage medium storing executable instructions that, when executed by an electronic apparatus, cause the electronic apparatus to perform any one of above disclosed methods at the terminal side.

FIG. 5 illustrates a block diagram of a server for performing any one of above disclosed methods at a server side. According to FIG. 5, the server includes at least one processor PRS1 and a storage medium STM1. FIG. 5 shows one processor PRS1 as an example.

The electronic apparatus can further include an input apparatus IPA1 and an output apparatus OPA1.

The one processor PRS1, storage medium STM1 and output apparatus OPA1 may be connected by a bus or other means. FIG. 5 shows a bus as an example for connection.

Storage medium STM1 is a non-transitory computer-readable medium for storing a non-transitory software program, a non-transitory computer-readable program and module, for example the program instructions/module for performing an above described method (e.g. request receiving module 310, order generation module 320 and quick response code module 330 shown in FIG. 3). The processor PRS1 can operate the various functions and data processing of a server to perform a method described in the above embodiments by executing non-transitory software programs, instructions and modules stored in the storage medium STM1.

The storage medium STM1 can include a program storage area and a data storage area. Among them, the program storage area may store operation system, application programs of at least one function; the data storage area may store generated data during operation of the electronic apparatus for performing the method described in the above embodiments. In addition, the storage medium STM1 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM1 may include a storage medium that is remote to the processor PRS1. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA1 can receive input number or byte information, and can generate input key information relating to user setting and functional control of the electronic apparatus for performing the method described in the above embodiments. The output apparatus OPA1 may include a display device such as a display screen.

The one or more modules stored in the storage medium STM1 that, when executed by the one or more processors PRS1, can perform any of the above described methods.

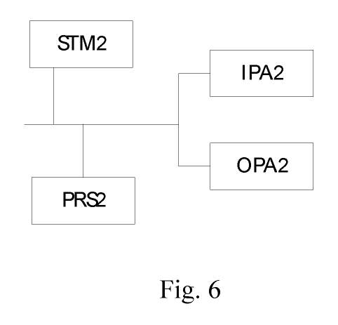

FIG. 6 illustrates a block diagram of a terminal for performing any one of above disclosed methods at the terminal apparatus side. According to FIG. 6, the terminal apparatus includes at least one processor PRS2 and a storage medium STM2. FIG. 5 shows one processor PRS2 as an example.

The electronic apparatus can further include an input apparatus IPA2 and an output apparatus OPA2.

The processor PRS2, storage medium STM2 and output apparatus OPA2 may be connected by a bus or other means. FIG. 6 shows a bus as an example for connection.

Storage medium STM2 is a non-transitory computer-readable medium for storing a non-transitory software program, a non-transitory computer-readable program and module, for example the program instructions/module for performing an above described method (e.g. quick response code scanning module 410, payment recognition module 420 and order sending module 430 shown in FIG. 4). The processor PRS2 can operate the various functions and data processing of a server to perform a method described in the above embodiments by executing non-transitory software programs, instructions and modules stored in the storage medium STM2.

The storage medium STM2 can include a program storage area and a data storage area. Among them, the program storage area may store operation system, application programs of at least one function; the data storage area may store generated data during operation of the electronic apparatus for performing the method described in the above embodiments. In addition, the storage medium STM2 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM2 may include a storage medium that is remote to the processor PRS2. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA2 can receive input number or byte information, and can generate input key information relating to user setting and functional control of the electronic apparatus for performing the method described in the above embodiments. The output apparatus OPA2 may include a display device such as a display screen.

The one or more modules stored in the storage medium STM2 that, when executed by the one or more processors PRS2, can perform any of the above described methods.

The above products can perform any of the above described methods, and have corresponding functional modules and effects. Details that are not disclosed in this embodiment can be understood by reference to the above method embodiments of the present disclosure.

It should be noted that according to the needs of implementations, each part/step described in this application may be divided into more parts/steps, and also two or more parts/steps or some operations of parts/steps may be combined into a new part/step, so as to achieve the objective of the embodiments of the present disclosure.

The foregoing method according to the embodiments of the present disclosure may be implemented in hardware or firmware, or may be implemented as software or computer code that can be stored in a recording medium (for example, a CD ROM, a RAM, a floppy disk, a hard disk or a magneto-optical disc), or may be implemented as computer code downloaded from a network that is originally stored in a remote recording medium or a non-transitory machine readable medium and will be stored in a local recording medium. Accordingly, the method described herein can be processed by such software that is stored in a recording medium that uses a general-purpose computer, a special-purpose processor or programmable or special-purpose hardware (for example, an ASIC or an FPGA). It may be understood that a computer, a processor, a microprocessor controller or programmable hardware includes a storage component (for example, a RAM, a ROM, and a flash memory, etc.) that can store or receive software or computer code. When the software or computer code is accessed and executed by the computer, the processor or the hardware, the processing method described herein is implemented. In addition, when the general-purpose computer accesses the code that is used for implementing processing shown herein, execution of the code converts the general-purpose computer to a special-purpose computer configured to execute the processing shown herein.

The foregoing descriptions are merely specific implementation manners of the embodiments of the present disclosure, but the protection scope of the present disclosure is not limited thereto. Any variation or replacement that can be readily conceived of by a person skilled in the art within the technical scope of the present disclosure should fall within the protection scope of the present disclosure. Therefore, the protection scope of the present disclosure should be defined by the claims.

What is claimed is:

1. A method for generating a quick response code, which is applied to a server, comprising:
receiving a quick response code request of a user;
obtaining a first general information in the quick response code request, to generate a first order information; and
generating a quick response code according to the first order information.

2. The method according to claim 1, further comprising:
displaying the quick response code by a proxy page.

3. The method according to claim 2, further comprising: automatically jumping to the proxy page displaying the quick response code, after the quick response code is generated.

4. The method according to claim 1, wherein the first general information comprises commodity information and/or price information.

5. A server, comprising:
at least one processor; and a memory communicably connected with the at least one processor for storing instructions executable by the at least one processor;
wherein execution of the instructions by the at least one processor causes the at least one processor to:
receive a quick response code request of a user;
obtain a first general information in the quick response code request, to generate a first order information; and
generate a quick response code according to the first order information.

6. The server according to claim 5, wherein the at least one processor is further caused to:
display the quick response code by a proxy page.

7. The server according to claim 6, wherein the at least one processor is further caused to:
jump to the proxy page displaying the quick response code automatically, after the quick response code is generated.

8. The server according to claim 5, wherein the first general information comprises commodity information and/or price information.

9. A terminal comprising:
at least one processor; and a memory communicably connected with the at least one processor for storing instructions executable by the at least one processor;
wherein execution of the instructions by the at least one processor causes the at least one processor to:
scan a quick response code to obtain first general information;
identify payment information of a code scanning application; and
send second order information to a server device according to the first general information and the payment information.

10. The terminal according to claim 9, wherein the at least one processor is further caused to jump to a payment page in response to the second order information.

11. The method according to claim 2, wherein the first general information comprises commodity information and/or price information.

12. The method according to claim 3, wherein the first general information comprises commodity information and/or price information.
